(19) United States
(12) Patent Application Publication
(10) Pub. No.: US 2026/0051414 A1
(43) Pub. Date: Feb. 19, 2026

(54) PASSIVE BUOYANCY DRIVEN FLUID SYSTEM

(71) Applicant: GEORGIA TECH RESEARCH CORPORATION, Atlanta, GA (US)

(72) Inventors: Srinivas Garimella, Atlanta, GA (US); Steven Biegalski, Atlanta, GA (US); Evan Ragoowansi, Atlanta, GA (US)

(21) Appl. No.: 18/962,507

(22) Filed: Nov. 27, 2024

Related U.S. Application Data
(60) Provisional application No. 63/682,614, filed on Aug. 13, 2024.

(51) Int. Cl. G21C 15/26; G21C 1/32; G21C 15/247

(52) U.S. Cl. CPC G21C 15/26; G21C 1/322; G21C 15/247

(57) ABSTRACT

A buoyancy driven fluid system coupled to a reactor system configured to achieve free convection operable to cool the reactor system is disclosed. The buoyancy driven fluid system of the present disclosure generates natural circulation by designing the reactor system to have a large vertical offset between the heat exchanger and the reactor core thereby generating a large buoyancy force between a thermal center of the reactor core and a thermal center of the heat exchanger. By ensuring that the sum pressure drop of the components connected to the primary fluid loop is no greater than the buoyancy force of the system, the fluid may circulate throughout the reactor system without the aid of pumps or other forced flow mechanism. The reactor system may be designed within certain size constraints to maintain a compact form while still providing free convection.

### RELATED APPLICATIONS

The present application relates and claims priority to U.S. Provisional Application No. 63/682,614, filed on Aug. 13, 2024, which is hereby incorporated by reference in its entirety.

### TECHNICAL FIELD

The present application generally relates to systems and methods for passively circulating coolant through a primary loop of a reactor system.

### BACKGROUND

Free convection, sometimes referred to as natural convection, passive circulation, or natural circulation, is caused by a change in density of a fluid due to a temperature change or gradient. Usually, the density decreases due to an increase in temperature and causes the fluid to rise. This motion is caused by the buoyancy force. Natural circulation of fluid may be advantageous for certain reactor systems.

A molten salt reactor (MSR) is a class of nuclear fission reactors that contain either a liquid salt coolant, a liquid salt coolant-fuel mixture, or a two-fluid blanket and fuel arrangement. MSRs can operate in the fast, thermal or epithermal neutron spectra, and can be set up to breed or simply burn fuel. Thermal reactor designs are typically moderated using graphite.

The liquid (or molten) salts of an MSR must be able to dissolve the fuel and blanket and allow for easy chemical separation of fission products after irradiation. They must also be chosen to maximize performance and safety. Typical salts can be made of fluorine, chlorine, lithium, sodium, potassium, beryllium, rubidium, and zirconium compounds. Fluoride-based salts are a typical choice for thermal spectrum reactor designs, as they absorb fewer neutrons and are better moderators than other halides. One of the benefits of MSR systems is a higher efficiency in generating electricity than Pressurized Water Reactors (PWRs) due to higher operating temperatures. Currently, potential designs of MSR systems are limited by their components due to operating temperatures exceeding 650° C. Namely, a pump may be necessary to circulate the molten salt throughout the MSR system. However, pumps may be prone to failure when operating at such high temperatures. Additionally, in the event of a loss of power or electrical outage, the loss of pump functionality may be devastating to the reactor system. Such a failure point may be obviated by providing a primary fluid loop operable to circulate coolant without the aid of a pump or forced flow device.

Thus, it is advantageous to design a reactor system (e.g., MSR system) with a passive cooling system that utilizes natural convection to circulate the coolant throughout the components of the reactor system without requiring a pump.

### SUMMARY OF THE INVENTION

In one example, a natural convection driven fluid system is disclosed. The example natural convection driven fluid system includes a primary fluid loop coupled to a reactor system configured to facilitate circulation of a carrier fluid through a plurality of components of the reactor system. The plurality of components comprises at least one heat exchanger having a first thermal center and a reactor core having a second thermal center. The at least one heat exchanger is positioned above the reactor core at an elevation sufficient to create a buoyancy force between the first thermal center and the second thermal center operable to drive natural convection of the carrier fluid through the primary fluid loop. The buoyancy force is at least equal to a sum pressure drop of the plurality of components.

In another example, the carrier fluid within the reactor core has a Reynolds number of 740 to 148000.

In another example, the carrier fluid has a Prandtl number of 0.0039 to 14.7.

In another example, the carrier fluid has a Grashof number of 2.9×10⁷ to 1.64×10¹⁰.

In another example, the carrier fluid is water.

In another example, the carrier fluid is molten salt.

In another example, the carrier fluid is molten metal.

In another example the reactor system does not include a pump connected to the primary fluid loop.

In another example, the reactor system is enclosed in a reactor enclosure; and wherein the natural convection driven cooling system is at least partially enclosed in the reactor enclosure.

In another example, the reactor enclosure is no larger than 12.2 meters long, 5.5 meters wide, and 5.5 meters deep.

In another example, the plurality of components includes a downcomer, a lower plenum, an upper plenum defined by a reactor vessel, a reactor core, and the at least one heat exchanger.

In another example, the reactor enclosure is of a compact size to be deliverable via a semi-trailer truck.

In another example, the at least one heat exchanger is a shell-and-tube heat exchanger.

In another example, the magnitude of the height difference is about 5.7 meters, wherein the diameter of the at least one heat exchanger is about 0.96 meters, and wherein the at least one heat exchanger includes a plurality of core channels, each of the core channels having a diameter of about 0.05 meters, and a plurality of tubes, each of the tubes having a diameter of about 0.005 meters.

In one example, a natural convection driven fluid system for a molten salt reactor is disclosed. The example natural convection driven fluid system for a molten salt reactor includes a reactor enclosure housing a reactor vessel, a reactor core and at least two heat exchangers. The reactor vessel defines a lower plenum, an upper plenum, and a downcomer. The natural convection driven fluid system for a molten salt reactor further includes a plurality of piping fluidly connecting the reactor core, the at least two heat exchangers, the lower plenum, the upper plenum, and the downcomer defining a molten salt loop such that molten salt flows therein. The reactor core, lower plenum, upper plenum, downcomer, and at least two heat exchangers each have a pressure drop that sum to a total pressure drop of the passive cooling system. The at least two heat exchangers define a first thermal center and the reactor core defines a second thermal center. The at least two heat exchangers are positioned above the reactor core at an elevation sufficient to create a pressure head between the first thermal center and the second thermal center operable to drive natural circulation of the molten salt through the molten salt loop. The total pressure drop of the passive cooling system is no greater than the pressure head thereby causing natural circulation of the molten salt.

In another example, the molten salt within the reactor core has an average Reynolds number of about 1260.

In another example, the molten salt has an average Prandtl number of about 8.3.

In another example, the molten salt has an average Grashof number of about 2.9×10⁷.

In another example, the reactor enclosure is no larger than 12.2 meters long, 5.5 meters wide, and 5.5 meters deep; and wherein the reactor enclosure is of a compact size to be deliverable via a semi-trailer truck.

In another example, the at least two heat exchangers are single-pass heat exchangers.

In another example, the molten salt reactor does not include a pump.

In one example, a method of naturally circulating a coolant through a primary coolant loop is disclosed. The example method includes providing a natural convection driven cooling system of the present disclosure. The example method further includes introducing a coolant to the natural convection driven cooling system. The example method further includes activating the reactor system thereby causing fission reaction to occur within the reactor core and a temperature of the coolant to increase. Upon activation of the reactor system the natural convection driven cooling system of the present disclosure creates a buoyancy force sufficient to cause the coolant to passively circulate throughout the reactor system.

### BRIEF DESCRIPTION OF THE FIGURES

FIG. 1 illustrates a schematic representation of an example molten salt reactor system.

FIG. 2 illustrates an example primary fluid thermal-hydraulic cycle of a buoyancy driven fluid system.

FIG. 3A illustrates an example buoyancy driven fluid system.

FIG. 3B illustrates a cross-sectional view of an example reactor vessel of the buoyancy driven fluid system of FIG. 3A.

FIG. 3C illustrates a cross-sectional view of another example reactor vessel of the buoyancy driven fluid system of FIG. 3A.

FIG. 4 illustrates a cross-sectional view of a portion of an example reactor core of a buoyancy driven fluid system.

FIG. 5 illustrates a cross-sectional view of an example heat exchanger of a buoyancy driven fluid system.

FIG. 6 illustrates a cross-sectional view of a portion of an example heat exchanger of a buoyancy driven fluid system.

FIG. 7 illustrates a line graph of the effect of varying heat exchanger geometry on heat exchanger height offset of a buoyancy driven fluid system.

FIG. 8 illustrates a flow diagram of an example method for passively circulating a coolant through a primary fluid loop system.

### DESCRIPTION OF THE INVENTION

The present invention is directed to a passive buoyancy driven fluid system for loop-type nuclear reactor systems that is configured to utilize an exclusively buoyancy driven flow of a carrier fluid (e.g., molten fuel salt) to transfer heat from the reactor core to a secondary fluid (e.g., secondary molten salt) through the fluid loop. In many embodiments, the passive buoyancy drive fluid system is included in a loop-type molten salt reactor (MSR) system. In certain conventional MSRs, fuel salt undergoes a fission reaction in a reactor vessel. Such conventional MSRs may operate by pumping the fuel salt from the reactor vessel along a “loop,” (hence, loop-type) first to a primary heat exchanger, and then back to the reactor vessel so that the fuel salt may re-enter the reactor vessel for subsequent fission reactions. The reactor vessel, pump(s), heat exchanger(s) and/or other components may be fluidly coupled to one another by a series of pipes, flanges, and other connections, which may each present the possibility for leaks or other failure mechanisms. Conventional MSRs require the fuel salt to be at an elevated temperature (i.e., about 600-700° C.) to keep the fuel salt in a molten phase. However, the high temperature and corrosivity of the molten fuel salt presents many challenges to the components coming in contact with the molten fuel salt. For example, a pump operable to pump the molten fuel salt along the loop may deteriorate over time or otherwise be inoperable when exposed to such high temperature and corrosivity. Thus, it may be desirable to eliminate the requirement for the molten salt pump.

The present invention seeks to configure the molten salt loop, primary heat exchanger, and reactor vessel in such a way as to obviate the need for a pump in a loop-type reactor by providing free convention within the carrier fluid (e.g., molten fuel salt). Free convection may be achieved by placing the heat exchanger at an elevation above the reactor vessel sufficient enough to generate a buoyancy force to circulate the carrier fluid throughout the primary fluid loop. However, with a larger elevational offset between heat exchanger(s) and the reactor vessel comes a larger, bulkier reactor system which may be undesirable. In this regard, the inventors have found optimized reactor parameters to maximize the buoyance force while minimizing its impact on the size of the reactor system. Stated otherwise, the reactor system (i.e., molten salt loop, salt-bearing components, etc.) has be designed to be as compact as possible while still providing a buoyancy force sufficient to cause natural convection within the fluid loop during operation. This may be referred to as “optimizing parameters.” In various embodiments, such parameters include the elevational offset between the heat exchanger(s) and reactor vessel or reactor core, the internal geometry or configuration of the heat exchanger(s) (e.g., number of coolant tubes, passes, etc.), the number of heat exchangers used, the number of fluid passages within the reactor core, internal configuration of the reactor vessel, and/or the number of bends within the fluid loop. Advantageously, the passive buoyancy driven fluid system eliminates or obviates the need for active components, such as a pump, traditionally required to circulate the carrier fluid through a loop-type reactor. Such active components create a potential point of failure, the absence of which creates a safer reactor system. Furthermore, the passive buoyancy driven fluid system is configured to enable continual heat removal even in the event of loss of external power (i.e., passively circulated). Thus, even during an electrical failure or shutdown event, the carrier fluid may continually circulate through the fluid loop.

While the present disclosure may describe the buoyancy driven fluid system as being tailored for use in an MSR system utilizing a molten salt as the carrier fluid (e.g., FLiBc, FLiNaK, NaCl, or KCl), one of ordinary skill in the art will appreciate that the buoyancy driven fluid system may be adapted to produce natural circulation in reactor systems that utilize other fluids or coolants within their loop. For example, the buoyancy driven fluid system may be coupled to a reactor system that utilizes water (e.g., light water or heavy water) or molten metal (e.g., sodium, lead, or lead-lithium) as a coolant. Such adaptations will be discussed in more detail herein.

The buoyancy driven fluid system is configured such that each thermal-hydraulic component (i.e., salt-bearing) is configured to balance the buoyancy forces with the frictional forces therein. In some embodiments, the buoyancy driven fluid system is coupled to a reactor system with a graphite moderated 200 MW thermal power core that utilizes a mixture of FLiBe (2LiF—BeF₂) as the carrier fluid and UF₄ as the fuel, respectively operating at temperatures from 650° C. to 950° C. For clarity, the buoyancy driven fluid system may be the primary loop of a reactor system, that is, the loop operable to transfer heat produced in the reactor core to a heat exchanger and back into the reactor core.

The passive cooling system may further be coupled to one or more heat exchangers placed above an upper plenum of the reactor vessel. The heat exchanger may be positioned vertically offset from the reactor vessel (containing the reactor core) to generate a height difference between a thermal center of the reactor core and a thermal center of the one or more heat exchangers. This height and temperature difference must be sufficiently large enough to generate a buoyancy force sufficient to drive the flow of fluid without external aid. However, with an increased height difference, comes a larger and bulkier reactor system, which may not be desirable when spatial constraints are at issue. For example, with a larger reactor system comes a larger reactor enclosure, a higher volume of carrier fluid, and larger reactor components, all of which increase the cost of manufacture and deployment. Thus, the present invention contemplates a maximum height limit of the reactor enclosure (i.e., an enclosure housing the reactor system). In this regard, the elevational offset between the heat exchanger(s) and reactor vessel is limited. Heat exchanger(s) with specific internal geometries/parameters must be employed to counteract this maximum height because the sum of the pressure drop in the heat exchangers, along with the other salt-bearing components in the loop, must match the buoyancy pressure difference to cause natural convention. As such, the present disclosure contemplates a heat exchanger configuration that leverages its internal geometries to minimize frictional forces and maximize heat transfer, which in turn increases the buoyancy force making the most out of the maximum elevational offset. Such parameters may include, more than one heat exchanger being employed, a heat exchanger configuration, the number of internal secondary fluid tubes employed, diameter of internal secondary fluid tubes, all of which will be discussed in more detail herein.

The buoyancy driven fluid system may employ single-pass, shell-and-tube heat exchangers with a large number of internal tubes to provide adequate pressure drop advantageously minimizing frictional forces and maximizing heat transfer. For example, the single-pass, shell-and-tube may include between 7000 and 8000 internal tubes, at least 5000 internal tubes, at least 6000 internal tubes, and preferably around 7715 internal tubes. By doing so, the buoyancy force created by the elevational offset of the thermal centers of the heat exchangers and reactor core may be increased and the flow impedance, due to friction forces, may be minimized or otherwise reduced.

As previously mentioned, the present invention provides certain embodiments that contemplate a reactor system design with dimensional constraints that provide a compact form while still enabling free convection (i.e., passive cooling). This may be advantageous where spatial constrains are at issue. More specifically, the overall dimensions of the reactor system (to which the buoyancy driven fluid system is coupled) may be constrained to allow complete assembly within a factory and provide efficient shipment of said reactor system (or modules thereof) by being of a size small enough to be shipped via roadways. For example, the reactor system and buoyancy driven fluid system may be enclosed within a reactor vessel deliverable to a reactor site via a semi-trailer truck (i.e., no larger than 12.2 meters long and 5.5 meters wide and tall). However, the buoyancy driven fluid system may be employed to a reactor system without such size constraints while providing free convection. The buoyancy driven fluid system may also be configured to provide free convection in reactor systems utilizing a water, molten salt, or molten metal coolant.

In several embodiments, the present invention is directed to a buoyancy driven fluid system coupled to a MSR system forming the primary loop and capable of maintaining a natural convection flow at full power. The buoyancy driven fluid system may be configured within the available pressure difference possible due to buoyancy as the driving force. The buoyancy driven fluid system and reactor system may generally include a reactor enclosure housing at least one heat exchanger, a reactor vessel, and piping therebetween. The reactor vessel may include the reactor core and define a lower plenum, an upper plenum, and a downcomer. The piping may facilitate flow of coolant to the aforementioned components and define a loop. For clarity, MSR system and buoyancy driven fluid system of the present invention may not be a pool-type reactor and may be a loop-type reactor, as understood by those of ordinary skill in the art. The reactor core, lower plenum, upper plenum, downcomer, heat exchangers, and piping therebetween may each include a pressure drop that sum to produce a total pressure drop of the system. The heat exchanger or heat exchangers may be positioned within the reactor enclosure above the reactor vessel and define a thermal center. The reactor core may also define a thermal center. The height difference between the thermal center of the reactor core and the heat exchangers creates a buoyancy force. The buoyancy force may be at least equal to the total pressure drop of the components. Thus, the elevational offset of the thermal centers is sufficient enough to generate a buoyancy head capable of causing natural convection throughout the primary loop.

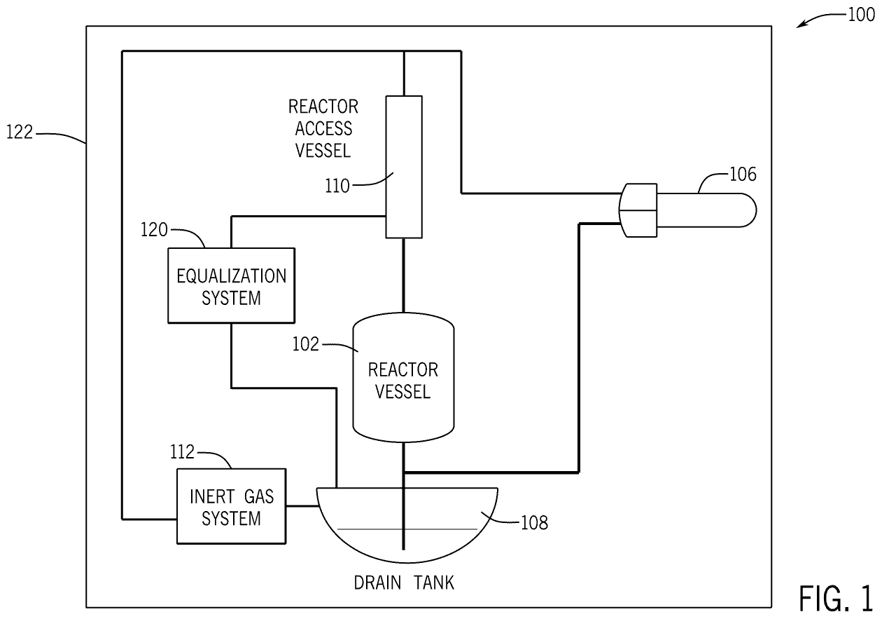

Turning now to the Figures. FIG. 1 illustrates a schematic representation of an example reactor system 100, such as a MSR system. As will be understood, the example shown in FIG. 1 represents merely one example configuration of a reactor system 100 which the buoyancy driven fluid system and associated components may be coupled to or implemented into. In other examples, the buoyancy driven fluid system may be implemented with substantially any other nuclear reactor system. In various embodiments, and as illustrated in FIG. 1, a primary reactor pump is not included in the reactor system 100. The example reactor system 100 may utilize fuel salt (i.e., the carrier fluid) enriched with uranium (e.g., high-assay low-enriched uranium) to create thermal power via nuclear fission reaction. In at least one example, the carrier fluid is a composition of molten fuel salt and may be LiF—BeF₂—UF₄, though other compositions of carrier fluids may be utilized within reactor system 100. In this example, the molten fuel salt within MSR system 100 may be heated to high temperatures (e.g., 625° C. and greater) and melt as MSR system 100 is heated. The reactor system 100 may utilize external heaters to initially bring the fuel salt into a molten phase.

As illustrated in FIG. 1, the reactor system 100 includes a reactor vessel 102 where nuclear fission reactions occur within the carrier fluid. The MSR system 100 may include additional components, such as, but not limited to, a drain tank 108, a reactor access vessel 110, a heat exchanger 106, and piping therebetween. In several embodiments, the piping defines a loop for the carrier fluid to travel to each salt bearing component. The drain tank 108 may be generally configured to store the carrier fluid once the fluid (i.e., molten fuel salt) is in the reactor system 100 but in a subcritical state, and also act as storage for the carrier fluid where power is lost to the MSR system 100. The reactor access vessel 110 may be configured to allow for introduction of pellets of uranium tetrafluoride (UF₄) or beryllium to the reactor system 100 as necessary to bring the reactor to a critical state and compensate for depletion of fissile material. The heat exchanger 106 may be generally configured to remove heat from the reactor system 100 to a secondary salt (e.g., LiF—BeF₂).

In several embodiments, the reactor system 100 is at least partially enclosed by a reactor enclosure 122. The reactor enclosure 122 may generally comprise a thermal insulation layer and an outer radiation shielding layer. In several embodiments, the reactor enclosure 122 includes a thermal insulation layer defining a thermal region therein operable to maintain a high temperature necessary to maintain a molten phase of the fuel salt (i.e., 600-700° C.). In various embodiments, all or substantially all salt-bearing components (i.e., those containing fuel salt, or making contact with fuel salt) are disposed within the thermal region. The insulating layer effectively functions as an oven by insulating the heat produced via fission reaction (or by external heaters) within the reactor vessel 102 to maintain a temperature of the MSR system 100. In several embodiments, and as discussed in more detail herein, the reactor enclosure 122 may be of a compact form. For example, the reactor enclosure 122 may be of a size to fit on the back of a tractor-trailer. As another example, the reactor enclosure may be no larger than 12.2 meters long, 5.5 meters wide, and 5.5 meters deep.

In several examples, the molten salt reactor system 100 may include an inert gas system 112 to provide inert gas to a head space of the drain tank 108, among other functions. The inert gas system 112 may further relieve inert gas from the head space of the drain tank 108 as needed. The inert gas system 112 is therefore operable to maintain pressurized inert gas in the head space of the drain tank 108 that is sufficient to substantially prevent the flow of molten fuel salt into the drain tank during normal operations (e.g., non-shutdown operations). For example, with the head space of the drain tank 108 pressurized by the inert gas system 112, molten salt may generally circulate between the reactor vessel 102 and the heat exchanger 106 without substantially draining into the drain tank 108. As described herein, the inert gas system 112 may be configured to supply inert gas to the head space of various other components of the molten salt reactor system 100, such as to the head space of the reactor access vessel 110, to the seal of reactor pump 104, among other components. Upon the occurrence of a shutdown event, the inert gas system 112 may cease providing inert gas to the head space of the drain tank 108, and other components to which the system 112 supplies inert gas.

The molten salt reactor system 100 may further include an equalization system 120 that is operable to equalize the pressure between the head space of the drain tank 108 and the reactor vessel 102 upon the occurrence of a shutdown event. For example, during normal operation a pressure differential exists between the head space of the drain tank 108 and the reactor vessel 102. Such pressure differential prevents or impedes the draining of the fuel salt into the drain tank 108. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event. The reactor system 100 of FIG. 1 may include other components not explicitly illustrated herein but understood by those of ordinary skill in the art.

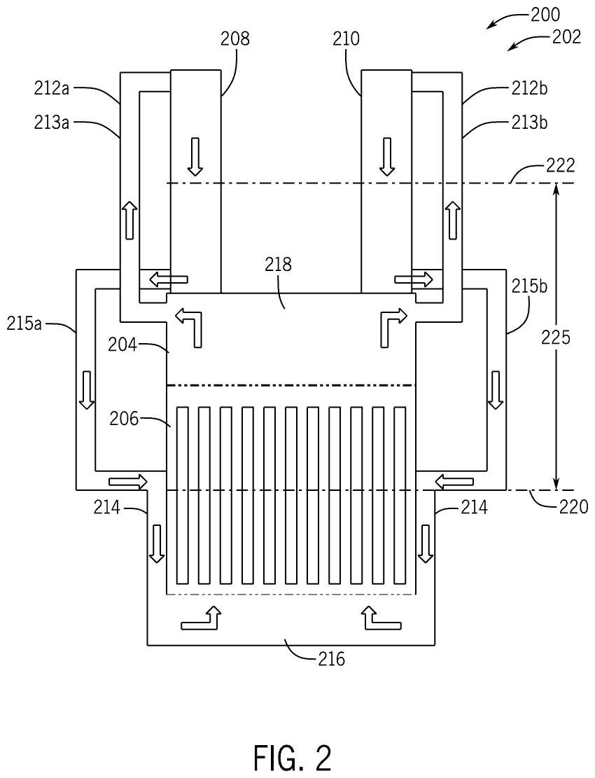

FIG. 2 illustrates an example primary fluid thermal-hydraulic cycle of a buoyancy driven fluid system 200. FIG. 2 highlights the thermal-hydraulic cycle of the buoyancy driven fluid system 200. The example buoyancy driven fluid system 200 may be coupled to or integrated in an example reactor system 202. For clarity, the example buoyancy driven fluid system 200 is the primary loop of the reactor system 202, that is, the system operable to circulate the carrier fluid (e.g., molten fuel salt containing the fissile material) from the reactor core to the heat exchangers, thereby removing heat from the reactor system 202 and consequently facilitating power generation. For additional clarity, the example reactor system 202 refers to a system operable to produce heat by facilitating fission reaction within a reactor core while the example buoyancy driven fluid system 200 refers to the primary fluid loop facilitating transfer of that heat from the reactor system 202. One of ordinary skill in the art will appreciate how these two systems are closely intertwined and that components made in reference to either system may be viewed as being a part of the example buoyancy driven fluid system 200 and the example reactor system 202. In several embodiments, the reactor system 202 is an MSR system and the buoyancy driven fluid system 200 facilitates flow of a molten fuel salt (e.g., LiF—BeF₂—UF₄). The buoyancy driven fluid system 200 may be generally operable to remove heat from the reactor system 202 to a secondary coolant (e.g., a secondary molten salt).

The example reactor system 202 may generally include a reactor vessel 204, a reactor core 206, a first heat exchanger 208, a second heat exchanger 210, and a first piping loop 212a, and a second piping loop 212b. The reactor vessel 204 may define or include a downcomer 214, a lower plenum 216, and an upper plenum 218. The downcomer 214 may be an annulus surrounding the lower half of the reactor vessel 204 fluidly coupled to the reactor core 206. The lower plenum 216 may be a region of the reactor vessel 204 below the reactor core 206 where molten fuel salt enters the reactor core 206, that is a portion of the reactor vessel 204 where the carrier fluid flows prior to entering the reactor core 206. The upper plenum 218 may be a region of the reactor vessel 204 above the reactor core 206 where molten fuel salt exits the reactor core 206, that is a portion of the reactor vessel 204 where the carrier fluid flows following exit of the reactor core 206 and prior to flowing into the first piping loop 212a or second piping loop 212b. The piping loops 212a, 212b may be configured to facilitate flow of the molten salt through the lower plenum 216, reactor core 206, upper plenum 218, first heat exchanger 208, and second heat exchanger 210. Such flow may generally proceed according to the arrows of FIG. 2. In this way, the first and second piping loop 212a, 212b may be collectively referred to as a primary loop and may be generally operable to facilitate flow of the coolant through the components of the reactor system 202.

The reactor core 206 may be a graphite core and generally operable to facilitate fission reaction within the carrier fluid (i.e., molten fuel salt), causing the carrier fluid to increase in temperature. The reactor core 206 may include or define a thermal center 220 generally about the center of the reactor core 206. In some embodiments, the carrier fluid may enter the graphite channels of the reactor core 206 from the lower plenum 216 at about 650° C. and exit the reactor core 206 into the upper plenum 218 at about 950° C. The carrier fluid may then flow from the upper plenum 218 into a hot leg portion 213a, 213b of the first and second piping loop 212a, 212b leading to the first heat exchanger 208 and the second heat exchanger 210. The first heat exchanger 208 and second heat exchanger 210 may include or define a thermal center 222 generally about the center of the heat exchangers 208, 210. The distance 225 between the thermal center 220 of the reactor core 206 and the thermal center 222 of the heat exchangers 208, 210 may denoted as ΔL and refers to the length or distance between the thermal center 220 of the reactor core and the thermal center 222 of the first and second heat exchangers 208, 210. The carrier fluid may then transfer heat to a secondary fluid in the heat exchangers 208, 210. In some embodiments, the heated carrier fluid may transfer about 200 MW to the secondary fluid which may be a molten salt. Upon heat transfer, the carrier fluid may cool down to about 650° C., where it returns to the downcomer via a first and second cold leg 215a, 215b of first and second piping loop 212a, 212b leading to the downcomer 214. The cycle may then continue as shown by the arrows of FIG. 2.

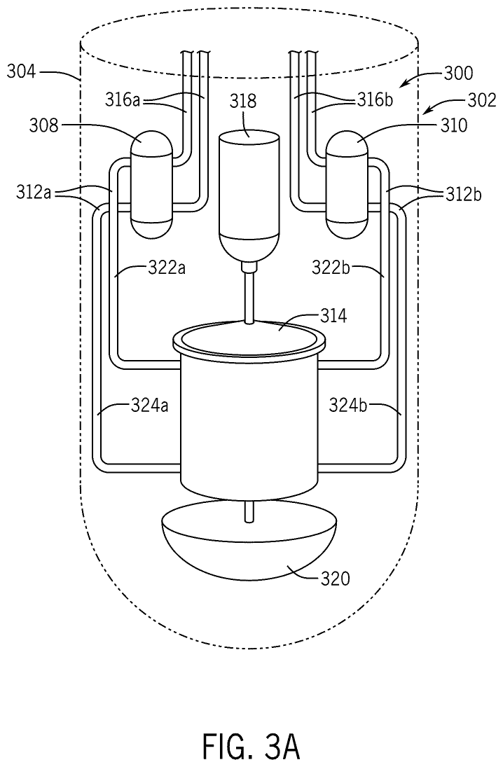

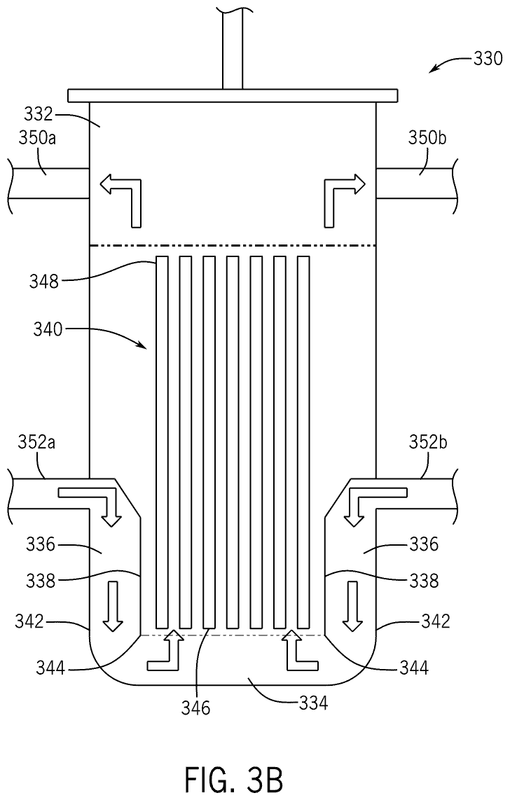

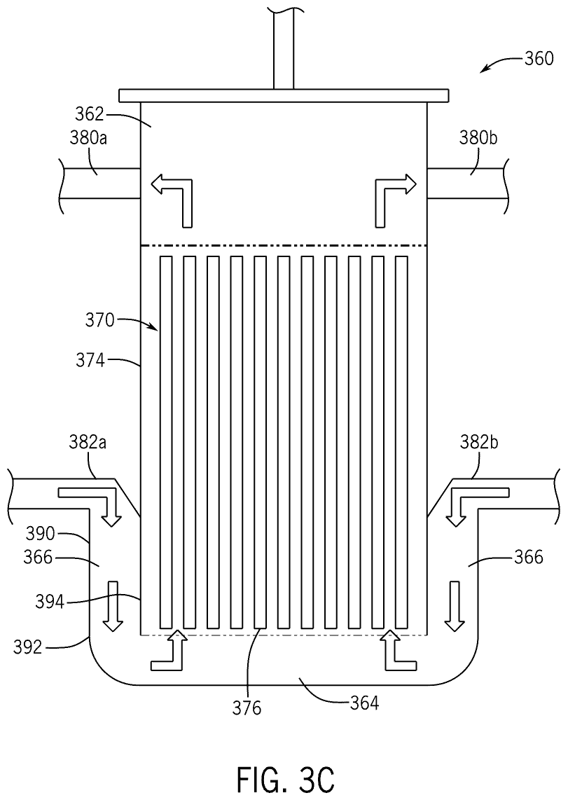

FIG. 3A illustrates an example buoyancy driven fluid system 300. The example buoyancy driven fluid system 300 may be coupled to an example reactor system 302 enclosed within a reactor enclosure 304. In several embodiments, the buoyancy driven fluid system 300 and reactor system 302 is substantially analogous to that of FIG. 2 and include a reactor enclosure 304, a first heat exchanger 308, a second heat exchanger 310, a first piping loop 312a, a second piping loop 312b, and a reactor vessel 314, redundant explanation of which is excluded for clarity.

However, FIG. 3A highlights other components that may be included for implementation of the buoyancy driven fluid system 300. For example, FIG. 3A includes a first secondary fluid loop 316a, a second secondary fluid loop 316b, a reactor access vessel 318, and a drain tank 320. Reactor vessel 314 may include a reactor core operable to facilitate fission reaction and heat generation within the carrier fluid (e.g., molten fuel salt). Following heat generation, the carrier fluid may circulate via hot leg portions 322a, 322b to their respective heat exchangers 308, 310. The first secondary fluid loop 316a may be configured to circulate a secondary fluid to and from the first heat exchanger 308 to facilitate heat transfer from the carrier fluid to the secondary fluid. Similarly, the second secondary fluid loop 316b may be configured to circulate a secondary fluid to and from the second heat exchanger 310 to facilitate heat transfer from the carrier fluid to the secondary fluid. In several embodiments, secondary fluid loops 316a, 316b are coupled to a heat removal system configured to extract heat from the reactor system 302 and return a cooled secondary fluid to each heat exchanger 308, 310. Following heat transfer, the carrier fluid may circulate via cold leg portions 324a, 324b back to reactor vessel 314. The cycle may continue as long as fission reaction is maintained.

Similar to FIG. 1, the reactor system 302 of FIG. 3A does not include a primary pump to pump the carrier fluid along the various piping loops (e.g., piping loops 312a, 312b, 316a, 316b) rather relaying on the buoyancy force produced by the temperature difference between a thermal center of the reactor core (within reactor vessel 314) and heat exchangers 308, 310 to passively drive fluid flow.

FIG. 3B illustrates a cross-sectional view of an example reactor vessel 330 of the buoyancy driven fluid system 300 of FIG. 3A. The example reactor vessel 330 defines an upper plenum 332, a lower plenum 334, and a downcomer 336. In several embodiments, the downcomer 336 is an annulus region formed within reactor vessel 330 defined by a partition 338 disposed within reactor vessel 330 and an outer wall 342 of reactor vessel 330. Downcomer 336 may be operable to direct incoming carrier fluid from piping 352a, 352b to the lower plenum 334 prior to entering the reactor core 340. In several embodiments, carrier fluid flowing from piping 352a, 352b is cooled carrier fluid from cold legs 324a, 324b of FIG. 3A. For clarity, while FIG. 3B illustrates a cross-sectional view, the reactor vessel 330 is a generally cylindrical shape and downcomer 336 is a lower annulus region thereof extending full about the reactor core 340. In this regard, partition 338 surrounds and is radially offset of reactor core 340.

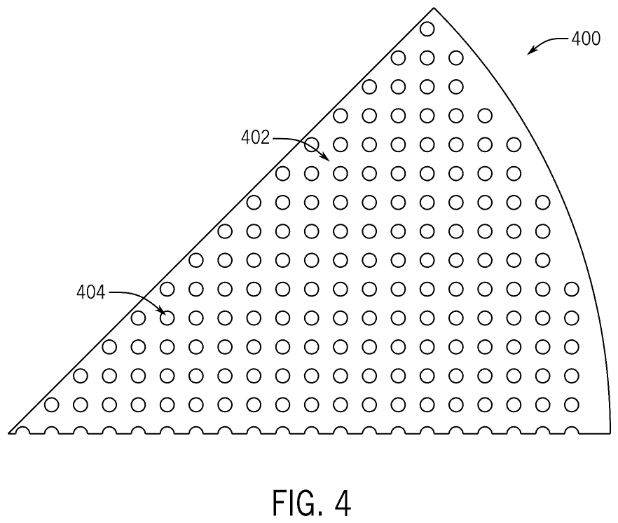

Lower plenum 334 may be defined as a lower section of reactor vessel 330 positioned at a lower terminating end 344 of partition 338. Lower plenum 334 is operable to receive carrier fluid from downcomer 336 and direct its flow up towards reactor core 340 at a lower end 346 of reactor core 340, such that it may rise through a plurality of lattices of reactor core 340 (see FIG. 4).

Upper plenum 332 may be defined as an upper section of reactor vessel 330 positioned at an upper end 348 of reactor core 340. Upper plenum 332 is operable to receive heated carrier fluid from reactor core 340 and direct its flow towards piping 350a, 350b. In various embodiments, piping 350a, 350b extends into hot leg portion 322a, 322b of FIG. 3A.

FIG. 3C illustrates a cross-sectional view of another example reactor vessel 360 of the buoyancy driven fluid system 300 of FIG. 3A. The example reactor vessel 360 may be substantially analogous to that of FIG. 3B and include an upper plenum 362, a lower plenum 364, a reactor core 370, piping 380a, 380b, and piping 382a, 382b redundant explanation of which is excluded for clarity. However, the example reactor vessel 360 of FIG. 3C illustrates a downcomer 366 not formed by an annulus of reactor vessel 360 but defined by a downcomer slip 390. Downcomer slip 390 may be a separate component wrapped about a lower section of reactor vessel 330 including an exterior wall 392 and inner wall 394. In this embodiment, downcomer 366 is defined by a section of downcomer slip 390 interposed between exterior wall 392 and inner wall 394. In this regard, inner wall 394 may terminate at a lower end 376 of reactor core 370, such that carrier fluid may flow from downcomer 366 into lower plenum 364 and rise through a plurality of lattices of reactor core 370 (see FIG. 4).

The example reactor system may be designed to have a compact form. Advantageously, by keeping the design of the reactor system within certain spatial confines, it may be transported within a reactor enclosure (e.g., reactor enclosure 122, 304) from a manufacturing facility to the power producing site via roads. In several embodiments, the overall dimensions of the reactor enclosure, and consequently the reactor system and buoyancy driven fluid system, is no larger than 12.2 meters long, 5.5 meters wide, and 5.5 meters deep. In some embodiments, the overall dimensions of reactor enclosure, and consequently the reactor system and buoyancy driven fluid system, is about 12.2 meters long, about 5.5 meters wide, and about 5.5 meters deep. Advantageously, by keeping the reactor system within the size constrains, the reactor vessel may be easily transported by shipment via truck or railway system. For example, by maintaining the dimensional constraints of the reactor system, the reactor system may be deliverable via semi-trailer truck. Notably, a reactor system and primary coolant loops of a larger size cannot be transported and delivered via semi-trailer truck or may require each individual component to be delivered separately. However, the size constraints may make it more difficult to configure the primary loop to cause free convection. This is due to the consequent limitation on the size of the offset between the thermal center of the heat exchangers and the thermal center of the reactor core. However, free convection may still be achieved by including heat exchangers with particular geometric configurations to maximize heat transfer and minimize friction.

Turning now to FIG. 4, which illustrates a cross-sectional view of a portion of an example reactor core 400. In several embodiments, the example reactor core 400 may be the reactor core 206 of FIG. 2, the reactor core 340 of FIG. 3B, and/or the reactor core 370 of FIG. 3C. In these embodiments, the reactor systems are graphite moderated. The reactor core 400 may comprise a graphite moderator 402 and a plurality of fluid channels 404 in a square lattice. For clarity, FIG. 4 illustrates a ⅛^{th} slice of the cylindrical reactor core 400. In several embodiments, the reactor core 400 is configured to meet the size constraints set forth above and enable free convection with the primary loop.

In several embodiments, the example reactor system and buoyancy drive cooling system described herein are housed within a reactor enclosure (e.g., reactor enclosure 122, 304) with the dimensions included in Table 1. Advantageously these size constraints cause the reactor enclosure to be about 12.2 meters long, about 5.5 meters wide, and about 5.5 meters deep, or no larger than 12.2 meters long, 5.5 meters wide, and 5.5 meters deep. In several embodiments, reactor core 206, 340, 370 and 400 are of the dimensions included in Table 1; lower plenum 216, 334, 354 are of the dimensions included in Table 1; upper plenum 218, 332, 362 are of the dimensions included in Table 1; lower plenum 216, 334, 364 are of the dimensions included in Table 1; downcomer 214, 336, 366 are of the dimensions included in Table 1; heat exchangers 208, 210 308, 310 are of the dimensions included in Table 1; piping 212a, 212b, 213a, 213b, 215a, 215b, 316a 316b, 312a, 312b, 322a, 322b, 324a, 324b are of the dimensions of Table 1; piping loops 212a, 212b, 312a, 312b are of the lengths per loop included in Table 1; and distance 225 is of the length included in Table 1.

TABLE 1

| Component | Size (meters) |
|---|---|
| Core, diameter | 4.6 |
| Core, height | 5.0 |
| Core, channel diameter | 0.0558 |
| Lower plenum, height | 0.5 |
| Upper plenum, height | 1.0 |
| Downcomer, height | 2.5 |
| Downcomer, hydraulic diameter | 0.06 |
| Heat exchanger, height | 5.7 |
| Piping diameter | 0.305 |
| Piping length per loop | 12 |
| Thermal center distance (ΔL) | 6.35 |

The example buoyancy driven fluid systems disclosed herein may be configured to produce natural convection driven flow in a primary loop of a reactor system, such that no pumps or other forced flow mechanism is required. Natural convection flow in the primary loop depends on the buoyancy driven pressure difference therein. A pressure head is determined based on the difference in height between the thermal centers of the heat exchangers and the reactor core, (e.g., distance 225 of FIG. 2. The example buoyancy driven fluid systems disclosed herein are configured to create a large buoyancy pressure head in order to drive the flow of coolant. For a reactor system to achieve free convection and passive fluid flow, the buoyancy force must be at least equal to a sum pressure drop of all the components of the reactor system (e.g., the reactor core 206, 340, 370, 400, the downcomer 214, 336, 366, the lower plenum 216, 334, 364, the upper plenum 218, 332, 362, the plurality of piping, and the heat exchangers 208, 210, 308, 310). The sum pressure drop is determined by adding the individual pressure drop of each component of the reactor system. In several embodiments, the reactor systems and passive cooling systems disclosed herein are designed such that the carrier fluid flows therein passively and without the aid of a pump system. Given the size constraints desired (i.e., small, and compact enough to facilitate easy transportation), specifically tailored heat exchangers must be utilized, ones that maximize the heat transfer and minimize frictional forces.

In order to ensure that the buoyancy driven fluid systems and example reactor system disclosed herein (e.g., reactor systems 100, 202, 302 and fluid systems 200, 300) are able to achieve free convection, that is, have a buoyancy force at least equal to the sum pressure drop of all components coupled to the primary fluid loop, the pressure drop of each component must be determined. Utilizing the dimensions disclosed in Table 1, along with other characteristics of the reactor system and the carrier fluid, the pressure drop of each component may be determined. The discussion that follows demonstrates how the pressure drop of each component was determined in order to design the buoyancy driven fluid system of the present disclosure. The buoyancy driven fluid system 200, 300 and reactor system 100, 202, 302 may be designed with the dimensions of Table 1 and provide free convection of carrier fluid therein; however, the discussion that follows explains how the inventors determined the proper dimensions to create free convection within the passive cooling systems 200, 300. The discussion that follows supports the conclusion that passive cooling systems 200, 300 causes free convection of carrier fluid throughout the primary fluid loop of the reactor system 100, 202, 302 while abiding by the size constraints disclosed (i.e., about 12.2 meters long, about 5.5 meters wide, and about 5.5 meters deep or no larger than 12.2 meters long, 5.5 meters wide, and 5.5 meters deep).

The thermal properties of the carrier fluid (e.g., the FLiBe molten salt) may be determined by experimental data or utilizing national databases, such as the Idaho National Laboratory database. One of ordinary skill in the art will appreciate that there are known methods for determining thermal properties of coolants used in reactor systems, such as molten salts, water, and molten metals. In several embodiments, the heat duty of the reactor system (e.g., reactor system 100, 200, 302) is about 200 MW with a temperature increase in the reactor core (e.g., reactor core 206, 340, 370, 400) of about 300 K. Utilizing Equation 1, the mass flow rate through the core may be calculated.

$$\dot{Q} = \dot{m} {c}_{p} Δ T \qquad Equation 1$$

Here, \dot{Q} is the heat duty of the coolant in kW, m is the mass flow rate in kg, s⁻¹, cₚ is the heat capacity of the coolant in kJ kg⁻¹ K⁻¹, and ΔT is the reactor core temperature change in K. For the frictional pressure drop of the reactor system to be manageable, multiple loops between the core and the heat exchangers are introduced (e.g., first and second piping loops 212a, 212b for FIG. 2; first and second piping loops 312a, 312b of FIG. 3). The mass flow rate per loop may be used to determine the hydraulic resistance, R, using Equation 2, which will be used to relate the buoyancy force to the mass flow rate.

$${\dot{m}}_{loop} = {( \frac{2 β Q g \dot{Δ L} {ρ}^{2}}{{c}_{p} R} )}^{\frac{1}{2}} \qquad Equation 2$$

Here, β is the volumetric thermal expansion coefficient in K⁻¹, g is the acceleration due to gravity in m s⁻², ΔL is the distance between the thermal centers in meters, and ρ is the density of the coolant in kg m⁻³. Utilizing Equation 2, the thermophysical properties are calculated at the mean temperature of the carrier fluid (e.g., molten salt mixture). The hydraulic resistance may then be used to calculate the pressure drop that can be supported by the buoyancy force using Equation 3.

$$Δ {P}_{B} = \frac{1}{2} R \frac{\dot{{m}_{loop}}}{ρ} \qquad Equation 3$$

Here, ΔP_{B} is the change in pressure drop of the buoyancy in Pa. As previously stated, to sustain free convection and passive fluid flow, the buoyancy head must at least match the total or allowable pressure drop of each component in the primary fluid loop. Given that the geometry of the reactor vessel and the height of the heat exchangers are limited based on the size constraints disclosed, the width and inner geometry of the heat exchanger must be configured to enable passive flow.

The applicable pressure drop is the sum of the friction, expansion, and contraction pressure drops of each component in the primary coolant loop (e.g., heat exchangers, lower and upper plenum, reactor core, downcomer, and plurality of piping). Given the component sizes of Table 1, the total pressure drop in each component, except for the heat exchangers may be determined.

The frictional pressure drop in the reactor core (e.g., reactor core 206, 340, 370, 400) may be calculated utilizing the mass flow rate calculated in Equation 1, the geometric dimensions in Table 1, and Equation 4.

$$Δ {P}_{f r} = \frac{1}{2} f ρ {v}^{2} \frac{L}{D} \qquad Equation 4$$

Here, f is the friction factor, ΔP_{fr} is the pressure drop due to major frictional losses, v is the velocity of the coolant, L is the length of the reactor core, ρ is the density of the coolant, and D is the diameter of the reactor core.

While the frictional pressure drop of the downcomer (e.g., downcomer 214, 336, 366) may be calculated utilizing Equation 4, the flow in the downcomer occurs in a large annulus and is in the transition to turbulent flow. A variety of correlations can be utilized to calculate the friction factor for an annular component (i.e., fₐₙₙᵤₗᵤₛ) using the form of Equation 5. Additionally, the pressure drop in the piping (e.g., piping of piping loops 212a, 212b, 312a, 312b) includes both major and minor frictional losses, such as bends, expansions, and constraints in the flow path. Thus, Equation 6 is used to calculate minor losses, where k is the minor loss coefficient.

$${f}_{a n n u l u s} = 0.3164 R {e}^{- 0.25} \qquad Equation 5$$

$$Δ {P}_{minor} = \frac{1}{2} k ρ {v}^{2} \qquad Equation 6$$

Here, for piping with bends k=0.4, for expansions k=1, and for contraction k=0.55. In references to the example reactor system 202 and/or reactor system 302, four bends were considered for the piping per loop, and the frictional pressure drop for piping is calculated using Equation 4. Equation 5 may be interchanged with fₐₙₙᵤₗᵤₛ=f(Re, ε), wherein ε is the relative roughness of the piping. The upper plenums 218, 332, 363 and lower plenums 216, 334, 364 may be sections where the fluid flow experiences large expansions and contractions, thus the pressure drops for these components are modeled as minor losses using Equation 6. Thus, the pressure drop of downcomer 214, 336, 366, lower plenums 216, 334, 364, upper plenums 218, 332, 362, reactor core 206, 340, 370, and piping loops 212a, 212b, 312a, 312b therebetween may be determined. However, this leaves the pressure drop of the heat exchanger (or heat exchangers) to be determined (e.g., heat exchangers 208, 210, 308, 310).

As previously stated, while free convection may be more readily achieved by a great distance between the heat exchangers and reactor core, it is advantageous to keep this distance within the desired size constraints (i.e., about 12.2 meters long, about 5.5 meters wide, and about 5.5 meters deep or no larger than 12.2 meters long, 5.5 meters wide, and 5.5 meters deep), thus only the configuration of the heat exchanger may be altered to create a reactor system and primary fluid loops that cause free convection and is compact enough to be transported with relative case. In this regard, the one or more heat exchangers must be configured so that the pressure drop of the heat exchanger, along with the other components within the primary coolant loop (i.e., determined in the discussion above), at least matches the buoyancy pressure drop. In order to do so while maintaining the size constraints, the one or more heat exchangers must provide a large enough heat transfer surface area between the carrier fluid and secondary fluid. The inventors have designed and determined the optimized heat exchanger configuration (i.e., internal geometry/parameters) operable to facilitate natural convection. In several embodiments, the heat exchanger configuration includes the number of heat exchangers used, the type of heat exchanger, the number of internal tubes, and/or the diameter of each internal tube.

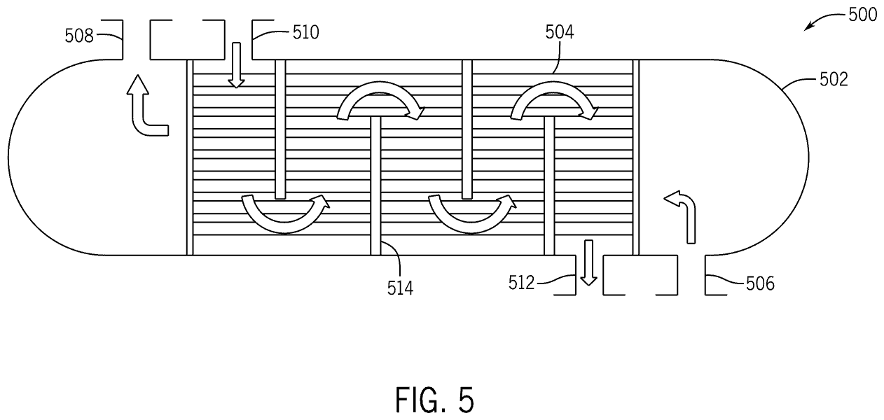

To facilitate the foregoing, and as contemplated in several embodiments, two single-pass, shell-and-tube heat exchangers are implemented into the buoyancy driven fluid system. Such a configuration may be utilized to meet pressure drop needs contemplated by the present disclosure. Advantageously, two single-pass, shell-and-tube heat exchangers allow for high heat transfer rates by providing a large heat transfer surface area between the primary and secondary fluids. FIG. 5 illustrates such an example heat exchanger configuration to be implemented into the buoyancy driven fluid system. In several embodiments, heat exchangers 208, 210, 308, 310 disclosed herein are substantially analogous to that described in reference to FIG. 5.

FIG. 5 illustrates a cross-sectional view of an example heat exchanger 500. In several embodiments, the example heat exchanger 500 is a single-pass, shell-and-tube heat exchanger. A single-pass heat exchanger may be required to achieve free convection in the primary fluid loop, as a two-pass heat exchanger would require a portion of the flow to be in a direction opposing buoyancy and increase the pressure drop. In several embodiments, the heat exchangers previously described (i.e., heat exchangers 208, 210, 308, 310) are substantially analogous to example heat exchanger 500 and include substantially the same internal geometry. The example heat exchanger 500 may generally include an outer shell 502 and a plurality of inner tubes 504 arranged within the outer shell 502. The plurality of inner tubes 504 may be configured to circulate a carrier fluid therethrough, such as a molten fuel salt, while the outer shell 502 may be configured to circulate a secondary fluid therethrough, such as a secondary salt. Example heat exchanger 500 may include a carrier fluid inlet 506 and a carrier fluid outlet 508 configured to introduce a carrier fluid coolant (e.g., molten fuel salt) into and out of the example heat exchanger 504. The example heat exchanger 500 may include a secondary fluid inlet 510 and secondary fluid outlet 512 configured to introduce a secondary fluid (e.g., molten salt) into and out of the example heat exchanger 500. The example heat exchanger 500 may also include a plurality of partitions or baffles 514 to facilitate fluid flow and fasten the plurality of internal tubes 504.

With reference to Table 2 and 3 and the associate discussion, the example heat exchanger 500 may include numerous internal tubes 504 to reduce frictional pressure drops to the required values and achieve free convection. For illustrative purposes, the example heat exchanger 500 of FIG. 5 includes a limited number of internal tubes 504. Example heat exchanger 500 may include up to 7,715 internal tubes 504. However, in other embodiments the example heat exchanger 500 may include about 7,715 internal tubes 500.

The plurality of inner tubes 504 may be positioned with the outer shell 502 such that the secondary fluid bathes the plurality of inner tubes 504, thereby promoting transfer of heat from the carrier fluid to the secondary fluid. Thus, the outer shell 502 and plurality of inner tubes 504 may be generally operable to transfer heat from the carrier fluid (e.g., molten fuel salt) to the second fluid (e.g., secondary molten salt). The example heat exchanger 500 may include numerous inner tubes 504 with particular diameters in order to facilitate passive flow. In several embodiments, the heat exchanger 500 includes characteristics shown in Table 3.

In several embodiments, the carrier fluid is a molten salt and fuel mixture that flows on the tube side, while the secondary fluid is a molten salt with an average temperature of about 550° C. and a mass flow rate of about 200 kg s⁻¹. However, one of ordinary skill in the art will appreciate that other fluids may be utilized, and that the passive coolant system may facilitate free convection within a reactor system with these other coolants.

To determine and ensure that the heat exchanger includes a low enough pressure drop required to promote free convection within the buoyancy driven fluid system, certain calculations must be made with references to characteristics of the primary fluid loop, reactor system, and carrier fluid. The inventors designed the heat exchanger(s) with optimized parameters to balance the need to lower the pressure drop while not over complicating the heat exchanger configuration (i.e., number of internal tubes), such as that illustrated in FIG. 5. The buoyancy driven fluid system 200, 300 and reactor system 100, 202, 302 may be designed with the dimensions of Table 1 and provide free convection of carrier fluid therein; however, the discussion that follows explains how the inventors determined the proper heat exchanger configuration needed to cause free convection within the passive cooling systems 200, 300. The passive cooling systems 200, 300 causes free convection of carrier fluid throughout the primary fluid loop of the reactor system 100, 202, 302 while abiding by the size constraints disclosed (i.e., about 12.2 meters long, about 5.5 meters wide, and about 5.5 meters deep or no larger than 12.2 meters long, 5.5 meters wide, and 5.5 meters deep) and as illustrated in the following discussion.

Initially, the heat transfer surface area, A, required to transfer 200 MW of thermal energy may be calculated utilizing Equation 7.

$${Q}_{loop} = UA \frac{( {T}_{p , i n} - {T}_{s , out} ) - ( {T}_{p , out} - {T}_{s , i n} )}{ln ( \frac{{T}_{p , i n} - {T}_{s , out}}{{T}_{p , out} - {T}_{s , i n}} )} . \qquad Equation 7$$

Here, \dot{Q}ₗₒₒₚ is the total heat duty per loop, U is the overall heat transfer coefficient, and Tₚ represents the temperature of the primary fluid or coolant. The overall heat transfer coefficient, U, may be calculated using Equation 8 and assumes the wall resistance of the tubes is negligible.

$$\frac{1}{U} = \frac{1}{{h}_{p}} + \frac{1}{{h}_{s}} \qquad Equation 8$$

Equation 8 provides values of 806 Wm⁻²K⁻¹ for hp and 3080 Wm⁻²K⁻¹ for hₛ.

The tube-side pressure drop in the heat exchanger may be calculated utilizing Equation 4. Thus, the number of tubes and the diameter of each must be iteratively solved to ensure that the required heat transfer surface area is provided and that the total pressure drop in the primary coolant loop, including the heat exchangers, matches the available buoyancy head. In some embodiments, the total pressure drop of the primary fluid loop, including the heat exchangers, is no greater than the available buoyancy head within the system. In some embodiments, the buoyancy head is at least equal to the total pressure drop of the primary fluid loop, including the heat exchangers. An iterative process may be conducted to determine that the buoyancy driven fluid system required two loops and two heat exchangers to maintain the disclosed size constraints and the dimensions of Table 1, hence the configurations present in FIGS. 2 and 3. Table 3 shows the resulting pressure drop in each component and demonstrates that the total pressure drop in each loop due to major and minor losses is equal to the buoyancy head calculated from Equations 1-3. Thus, Table 2 and 3 show the resulting geometric parameters (including the diameter of the primary fluid channels and the number of tubes) needed to provide the necessary heat transfer area to achieve free convection. In several embodiments, the example buoyancy driven fluid systems and example reactor system of the present disclosure the geometric parameters shown in Table 2 and 3. For example, the pressure drops included in table 2 at least substantially correspond to that of the components illustrated in FIGS. 2-3C. In several embodiments, heat exchangers 208, 210 308, 310 500 include the quantity and diameter of heat exchanger tubes included in Table 3. In several embodiments, reactor core 206, 340, 370, 400 include the number of core channels included in Table 3.

TABLE 2

| Component | Pressure drop (Pa) |
|---|---|
| Core | 9.1 |
| Downcomer | 160 |
| Lower plenum | 970 |
| Upper plenum | 534 |
| Piping | 2180 |
| Heat exchanger | 12887 |
| Total loop pressure drop | 16740 |
| Available buoyancy head | 16740 |

TABLE 3

| Component | Quantity | Diameter (m) |
|---|---|---|
| Core channels | 1320 | 0.0558 |
| Heat exchangers | 2 | 0.966 |
| Heat exchangers, tubes | 7715 | 0.00523 |

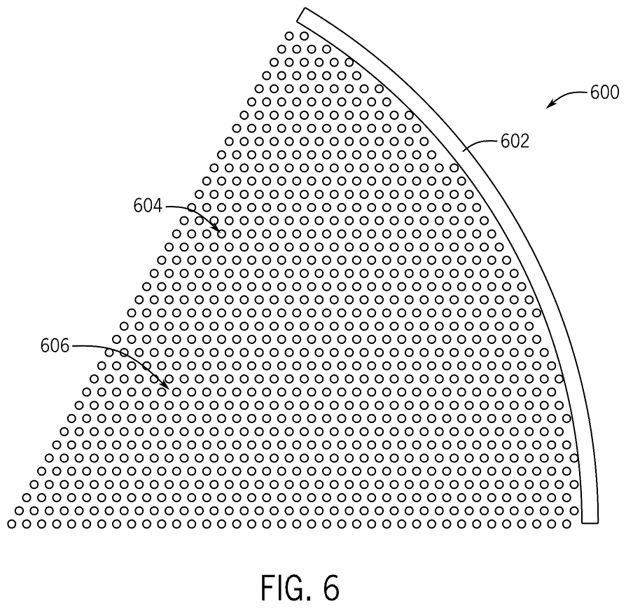

FIG. 6 illustrates a cross-sectional view of a portion of an example heat exchanger 600. For clarity, FIG. 6 illustrates a ⅙^{th} slice of the example heat exchanger 600 and does not include all tubes that may be included for illustrative ease. The example heat exchanger 600 may include the parameters shown in Table 2 and 3. In several embodiments, the internal configuration of heat exchanger 208, 210, 308, 310, 500 are substantially the same as heat exchanger 600. FIG. 6 illustrates to show the numerous internal tubes utilized to achieve free convention in the buoyancy driven fluid system discussed herein.

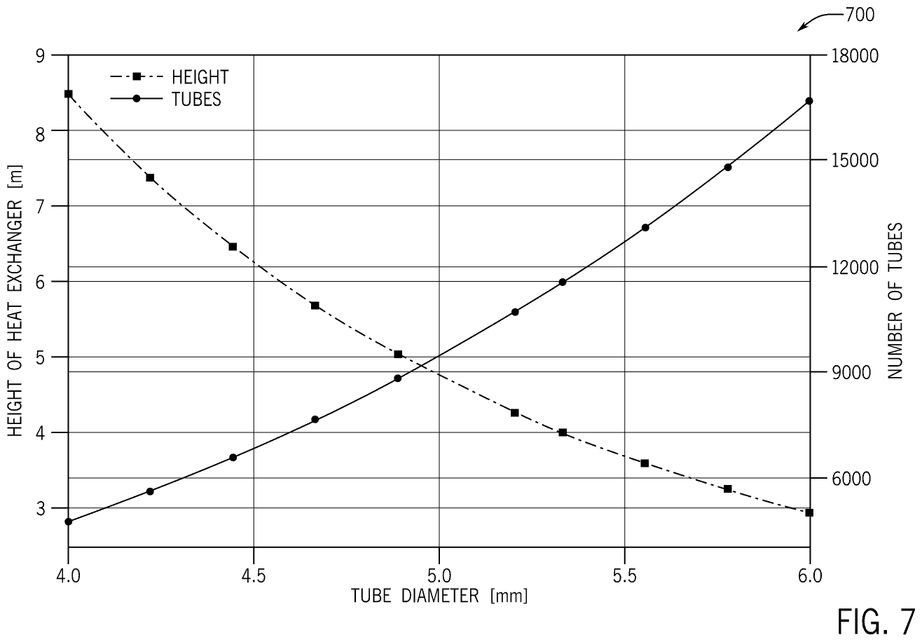

The above-described buoyancy driven fluid system is designed given certain sizing constraints (i.e., those creating a compact and easily transportable reactor system). However, the present invention contemplates buoyancy driven fluid system coupled to reactor systems that are not confined by size constraints. In this regard, the buoyancy driven fluid system may be integrated into other reactor systems of greater dimensions and still maintain free convection. FIG. 7 illustrates a line graph 700 that demonstrates the effect of varying heat exchanger geometry on heat exchanger height offset. By varying the height of the heat exchangers, the height difference between the thermal centers of the reactor core and heat exchangers are also varied, consequently causing the buoyancy force to change. FIG. 7 illustrates the multiple options for different sized heat exchangers, all yielding natural convective flow within the buoyancy driven fluid system. While it is advantageous to create a large thermal center offset to provide a large buoyancy force, a larger offset between the heat exchangers and reactor core may not allow for convenient transportation of the reactor vessel in one piece. Thus, while FIG. 7 illustrates a wide range of heat exchanger heights and internal geometry configurations contemplated by the present disclosure causing free convection.

FIG. 7 demonstrates a general trade-off between the height of the reactor system and the complexity of the heat exchanger. Stated otherwise, as the reactor system is allowed to increase in height the necessary complexity of the heat exchanger (i.e., required number of tubes and tube diameter) decreases. As the reactor system is constrained as to its height, the necessary complexity of the heat exchanger increases.

The present disclosure discusses various buoyancy driven fluid system embodiments coupled to a molten salt reactor system. However, the present disclosure is not limited to reactor systems that utilize a molten fuel salt to generate power.

The buoyancy driven fluid system of the present invention may be adapted to be coupled to a variety of reactor systems. For example, the buoyancy driven fluid system may be configured to passively circulate light water (i.e., normal water) as a coolant for a Light Water Reactor (LWR) or heavy water (i.e., D₂O) through a Pressurized Heavy-Water Reactor (PHWR). As another example, the passive cooling system may be configured to passively circulate molten salts (e.g., FLiBe, FLiNaK, NaCl, or KCl) through a thermal or fast reactor. As another example, the passive cooling system may be configured to passively circulate molten metals (e.g., Na, Pb, or PbBi) through a liquid metal cooled reactor (LMR). In several embodiments, the passive cooling system 200 may be modified to accommodate these different coolants.

The buoyancy driven fluid system may be configured to cause natural convection of several different coolants (e.g., water, molten salt, molten metal). Such natural convective coolant flow may be achieved while remaining within the disclosed size constraints (e.g., about 12.2 meters long, about 5.5 meters wide, and about 5.5 meters deep or no larger than 12.2 meters long, 5.5 meters wide, and about 5.5 meters deep) for the reactor power stated above (i.e., 200 MW) and only altering the internal geometry of the heat exchangers, the number of piping loops within the primary cooling loop, and the characteristics of the nuclear reactor. To one familiar with the art, similar buoyancy driven fluid system with appropriately different dimensional constraints may be designed to meet lower or higher reactor power levels. To illustrate this point, Table 4 shows a range of average coolant characteristics demonstrative of the different coolants that may be used. Stated otherwise, the buoyancy driven fluid system may utilize coolants exhibiting the nondimensional number ranges of Table 4 while maintaining natural convective flow.

TABLE 4

| Dimensionless quantity | Number range |
|---|---|
| Reactor core Reynolds Number | 1260-143000 |
| Prandtl number | 0.004-8.3 |
| Grashof number | 2.9E+07-1.64E+10 |

Table 5 shows the dimensional characteristics of the buoyancy driven fluid system and reactor system used to cause passive flow of different fluids (i.e., molten fuel salt). In several embodiments, the reactor system to which the buoyancy driven fluid system is coupled has a power level of about 200 MW.

TABLE 5

| | Molten salt | Liquid | |
|---|---|---|---|
| Fluid | (FLiBe) | Metal (Na) | Water (H₂O) |
| Loops | 2 | 2 | 4 |
| Reynolds number (core) | 740-1860 | 43000-57000 | 137000-148000 |
| Reynolds number (heat exchanger) | 675-1700 | 321000-426000 | 29400-31900 |
| Prandtl number | 5.4-14.7 | 0.0039-0.0044 | 0.823-0.971 |
| Core temperature rise (K.) | 300 | 300 | 50 |
| Grashof number (core) | 2.90E+07 | 9.82E+09 | 1.64E+10 |
| Diameter of heat exchanger tubing | 5.2 | 23.4 | 3.3 |
| (mm) | | | |
| Heat exchanger shell diameter (m) | 0.966 | 0.71 | 1.11 |
| Number of heat exchanger tubes | 7715 | 209 | 26064 |
| Core inlet temperature (° C.) | 650 | 550 | 275 |
| Core exit temperature (° C.) | 950 | 850 | 325 |
| Secondary fluid temperature (° C.) | 550 | 500 | 250 |
| Piping diameter (m) | 0.305 | 0.427 | 0.427 |
| Primary loop pressure | Ambient | Ambient | 15.2 MPa |

Thus, Table 5 establishes that the buoyancy driven fluid system, for example that of FIG. 2-3C, may be configured to passively circulate (i.e., without the aid of pumps or forced flow mechanism) a variety of fluids through a variety of reactor systems while staying within the disclosed size constraints.

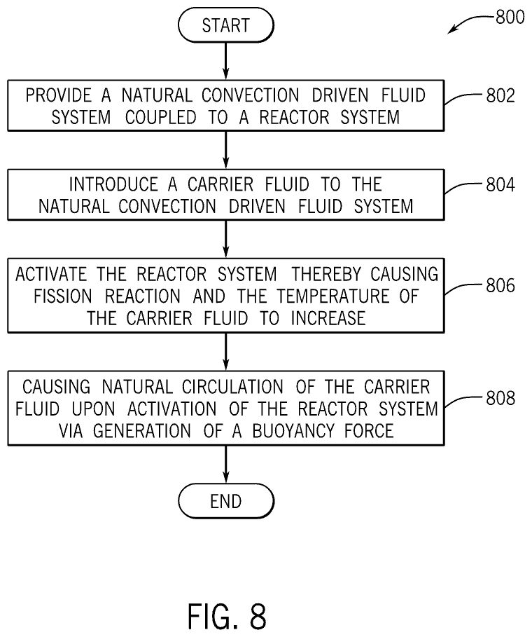

FIG. 8 illustrates a flow diagram of an example method 900 for passively circulating a fluid through a buoyancy driven fluid system. At step 802, a natural convection driven fluid system is provided. In various embodiments, the natural convection driven fluid system is a buoyancy driven fluid system 200 discussed with reference to FIG. 2 and/or the buoyancy driven fluid system 300 discussed with reference to FIGS. 3A-3C. In several embodiments, the natural convection driven fluid system is coupled to a reactor system, such as the example reactor system 100, 202, and/or 302. However, the natural convection driven fluid system may be coupled to an MSR system, a LWR system, a PHWR system, a fast reactor system, or other nuclear reactor system known in the art. The natural convection fluid system may include at least one heat exchanger vertically offset from the reactor core at a sufficient distance to create a large buoyancy force to drive the natural convection. In several embodiments, the natural convection fluid system includes two single-pass shell-and-tube heat exchangers with the dimensions disclosed in Table 1 and Table 3, such as that illustrated in FIG. 5 and FIG. 6. The natural convection driven fluid system may generally include a downcomer (e.g., downcomer 214, 336, 366), a lower plenum (e.g., lower plenum 216, 334, 364), a reactor core (e.g., reactor core 206, 340, 370), an upper plenum (e.g., upper plenum 218, 332, 362), and at least one heat exchanger (e.g., heat exchanger 208, 210, 308, 310, 500). In several embodiments, the reactor system may be designed within certain size constraints in order to keep the reactor system within a compact reactor enclosure for case of transport (e.g., reactor enclosure 122). For example, the size constraint may be about 12.2 meters long, about 5.5 meters wide, and about 5.5 meters deep. As another example, the size constraints may be no larger than 12.2 meters long, 5.5 meters wide, and about 5.5 meters deep. In several embodiments, the natural convection driven cooling system has the dimensions disclosed in Tables 1-3.

At step 804, a carrier fluid is introduced to the natural convection fluid system. In several embodiments, the fluid that is naturally circulated throughout the primary fluid loop and the fluid is a molten fuel salt (e.g., FLiBe and UF₄ mixture). However, the natural convection fluid system may be configured to accommodate a wide variety of fluids, such as molten salt, water, and molten metal. To accommodate other fluids, the natural convection fluid system may include the dimensions disclosed in Table 5.

At step 806, the reactor system is activated causing fission reaction to occur within the reactor core and causing the temperature of the carrier fluid to increase. The reactor core may be reactor core 206, reactor core 340 and/or reactor core 370 and include the internal configuration illustrated in FIG. 4. In several embodiments, the reactor system includes a graphite moderator with a plurality of channels for coolant to flow therethrough. The coolant may flow into the lower plenum (e.g., lower plenum 216, 334, 364) at about 650° C. before entering the graphite channels of the reactor core (e.g., reactor core 206, 346, 376) where the fluid may be heated to about 950° C. due to fission reaction.

At step 808, the activation of the reactor system causes the fluid to increase in temperature and consequently passively circulate throughout the reactor system. In several embodiments, free convection is achieved by designing the reactor system and primary fluid loop such that the buoyancy force created by a distance between the thermal centers of the reactor core and heat exchanger is at least equal to the sum pressure drop of the components of the reactor system. In several embodiments, the passive circulation occurs without the aid of pumps or forced flow mechanisms.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

I claim:

1. A natural convection driven fluid system comprising:
a primary fluid loop coupled to a reactor system configured to facilitate circulation of a carrier fluid through a plurality of components of the reactor system;
wherein the plurality of components comprises at least one heat exchanger having a first thermal center and a reactor core having a second thermal center;
wherein the at least one heat exchanger is positioned above the reactor core defining a height difference;
wherein the height difference is of a magnitude sufficient to create a buoyancy force between the first thermal center and the second thermal center operable to drive natural convection of the carrier fluid through the primary fluid loop; and
wherein the buoyancy force is at least equal to a sum pressure drop of the plurality of components.

2. The natural convection driven fluid system of claim 1, wherein the carrier fluid within the reactor core has a Reynolds number of 740 to 148000.

3. The natural convection driven fluid system of claim 1, wherein the carrier fluid has a Prandtl number of 0.0039 to 14.7.

4. The natural convection driven fluid system of claim 1, wherein the carrier fluid has a Grashof number of 2.9×10⁷ to 1.64×10¹⁰.

5. The natural convection driven fluid system of claim 1, wherein the carrier fluid is water.

6. The natural convection driven fluid system of claim 1, wherein the carrier fluid is a molten salt.

7. The natural convection driven fluid system of claim 1, wherein the carrier fluid is a molten metal.

8. The natural convection driven fluid system of claim 1, wherein the reactor system does not include a pump connected to the primary fluid loop.

9. The natural convection driven fluid system of claim 1, further comprising a reactor enclosure configured to house the primary fluid loop and the plurality of components of the reactor system.

10. The natural convection driven fluid system of claim 9, wherein the reactor enclosure is no larger than 12.2 meters long, 5.5 meters wide, and 5.5 meters deep.

11. The natural convection driven fluid system of claim 1, wherein the plurality of components comprises a downcomer, a lower plenum, an upper plenum defined by a reactor vessel, a reactor core, and the at least one heat exchanger.

12. The natural convection driven fluid system of claim 10, wherein the reactor enclosure is of a compact size to be deliverable via a semi-trailer truck.

13. The natural convection driven fluid system of claim 1, wherein the at least one heat exchanger is a shell-and-tube heat exchanger.

14. The natural convection driven fluid system of claim 13, wherein the magnitude of the height difference is about 5.7 meters, wherein the diameter of the at least one heat exchanger is about 0.96 meters, and wherein the at least one heat exchanger includes a plurality of core channels, each of the core channels having a diameter of about 0.05 meters, and a plurality of tubes, each of the tubes having a diameter of about 0.005 meters.

15. A natural convection driven fluid system for a molten salt reactor comprising:
a reactor enclosure housing a reactor vessel, a reactor core and at least two heat exchangers;
wherein the reactor vessel defines a lower plenum, an upper plenum, and a downcomer;
a plurality of piping fluidly connecting the reactor core, the at least two heat exchangers, the lower plenum, the upper plenum, and the downcomer and collectively defining a molten salt loop such that molten salt flows therein;
wherein the reactor core, lower plenum, upper plenum, downcomer, and at least two heat exchangers each have a pressure drop that sum to a total pressure drop of the natural convection driven fluid system;
wherein the at least two heat exchangers define a first thermal center and the reactor core defines a second thermal center;
wherein the at least two heat exchangers are positioned above the reactor core at an elevation sufficient to create a pressure head between the first thermal center and the second thermal center operable to drive natural circulation of the molten salt through the molten salt loop; and
wherein the total pressure drop of the natural convection driven fluid system is no greater than the pressure head thereby causing natural circulation of the molten salt.

16. The natural convection driven fluid system of claim 15, wherein the molten salt within the reactor core has an average Reynolds number of about 1260.

17. The natural convection driven fluid system of claim 15, wherein the molten salt has an average Prandtl number of about 8.3.

18. The natural convection driven fluid system of claim 15, wherein the molten salt has an average Grashof number of about 2.9×10⁷.

19. The natural convection driven fluid system of claim 15, wherein the reactor enclosure is no larger than 12.2 meters long, 5.5 meters wide, and 5.5 meters deep; and wherein the reactor enclosure is of a compact size to be deliverable via a semi-trailer truck.

20. The natural convection driven fluid system of claim 15, wherein the at least two heat exchangers are single-pass heat exchangers.

21. The natural convection driven fluid system of claim 15, wherein the molten salt reactor does not include a pump.

22. A method of naturally circulating a coolant through a primary fluid loop of a reactor system comprising:
providing the natural convection driven fluid system of claim 1 coupled to the reactor system;
introducing a carrier fluid comprising a fissile material to the natural convection driven fluid system;
activating the reactor system thereby causing fission reaction of the fissile material to occur within the reactor core and a temperature of the carrier fluid to increase;
wherein upon activation of the reactor system, the natural convection drive fluid system of claim 1 causes natural circulation of the carrier fluid via generation of a buoyancy force within the primary fluid loop sufficient to cause the carrier fluid to passively circulate throughout the primary fluid loop.

23. The method of claim 22, wherein the carrier fluid has a Reynolds number of about 1260 to about 143000 when within the reactor core; wherein the carrier fluid has a Prandtl number of about 0.004 to about 8.3; and wherein the carrier fluid has a Grashof number of about 2.9×10⁷ to about 1.64×10¹⁰.
